(19) United States
(12) Patent Application Publication
(10) Pub. No.: US 2024/0096533 A1
(43) Pub. Date: Mar. 21, 2024

(54) COIL COMPONENT

(71) Applicant: Mitsubishi Electric Corporation, Tokyo (JP)

(72) Inventors: Mao KAWAMURA, Tokyo (JP); Hayato TANABE, Tokyo (JP); Naohisa UEHARA, Tokyo (JP); Takashi SOBASHIMA, Miyagi (JP); Keisuke AKAKI, Miyagi (JP); Takuya ENDOU, Miyagi (JP); Yuki ABE, Miyagi (JP); Masahiro KONDO, Miyagi (JP); Norimitsu HOSHI, Miyagi (JP)

(73) Assignee: Mitsubishi Electric Corporation, Tokyo (JP)

(21) Appl. No.: 18/039,650

(22) PCT Filed: Feb. 17, 2021
(86) PCT No.: PCT/JP2021/005880

§ 371 Date: May 31, 2023

(51) Int. Cl. H01F 3/08; H01F 27/28

(52) U.S. Cl. CPC H01F 3/08; H01F 27/2823; H01F 27/025

(57) ABSTRACT

The coil component includes a coil, a first core having a first magnetic permeability, and a second core having a second magnetic permeability lower than the first magnetic permeability. The first core and the second core form a magnetic path. The coil forms two or more winding windows. The first core contacts with an entirety of one side line extending in a second direction of each of the winding windows, and protrudes from both ends of one side line of at least one of the winding windows. The second core contacts with three side lines other than the one side line of each of the winding windows. A surface resistance of the first core between two points that are 20 mm away from each other is not less than 5 Ω after a high-temperature storage test. A drive frequency of the coil component is not less than 20 kHz.

### TECHNICAL FIELD

The present invention relates to a coil component, and in particular, relates to a coil component including a core formed by combining two kinds of core portions.

### BACKGROUND ART

Patent Document 1 discloses a coil component including a core formed by combining two kinds of core portions. This coil component includes a lidless case, a dust core placed at the bottom of the case, a coil placed on the dust core, and a cast core filling the inside of the case and cured therein so as to surround the coil.

### CITATION LIST

### Patent Document

Patent Document 1: Japanese Patent No. 6673711

### SUMMARY OF THE INVENTION

### Problems to be Solved by the Invention

In general, iron produces black rust under a high-temperature environment. The same applies to iron used in a core included in a coil component. Black rust is more likely to be produced on a dust core than on a cast core, due to structure difference between the cast core and the dust core.

Black rust produced on the core changes the characteristics of the coil component. For example, black rust produced on the core increases eddy current loss in the core. In addition, black rust produced on the core increases the AC resistance of the coil component. The influence of change in the characteristics due to the black rust as described above becomes greater as the drive frequency applied to the coil component becomes higher.

Accordingly, an object of the present invention is to provide a coil component having stable characteristics such that change in the characteristics is small even at a high drive frequency.

### Solution to the Problems

One aspect of the present invention is a coil component including: a conductor which generates a magnetic flux by being energized; a core which is provided around the conductor and forms a magnetic path through which the magnetic flux circulates; and a case storing the conductor and the core. A drive frequency of the coil component is not less than 20 kHz. The conductor is a winding forming at least one coil having an axis along a first direction. The conductor has a cross-section forming a quadrangular winding window on a plane including the magnetic path. The plane includes the axis. The coil forms two or more said winding windows on the plane. The winding windows are arranged in a second direction perpendicular to the first direction. The core includes a first core having a first magnetic permeability and a second core having a second magnetic permeability lower than the first magnetic permeability. On the plane, the first core contacts with an entirety of one side line extending in the second direction of each of the winding windows, protrudes in the second direction from both ends of the one side line of at least one of the winding windows, and is located on a side opposite to the winding windows with respect to a line including the one side line of each of the winding windows. The second core contacts with three side lines other than the one side line of each of the winding windows on the plane. The case has a bottom and a side portion extending in one direction from the bottom. The first core contacts with the bottom. The first core is a dust core. A surface resistance of the dust core between two points that are 20 mm away from each other is not less than 5Ω after a high-temperature storage test.

### Effect of the Invention

According to the present invention, the dust core whose surface resistance between the two points that are 20 mm away from each other is not less than 5Ω after the high-temperature storage test, is used, whereby it is possible to provide a coil component having stable characteristics at a high drive frequency.

Through consideration of description of the following best-mode embodiment with reference to the accompanying drawings, an object of the present invention will be correctly understood and features thereof will be more completely understood.

### BRIEF DESCRIPTION OF THE DRAWINGS

FIG. 1 is a schematic sectional view showing a coil component according to an embodiment of the present invention. The coil component is cut along a plane including the axis of a coil and a magnetic path formed by a core.

FIG. 2 is a schematic sectional view showing a modification of the coil component shown in FIG. 1.

### DESCRIPTION OF EMBODIMENTS

While the present invention can be implemented in a variety of modifications and various embodiments, as an example thereof, a specific embodiment as shown in the drawings will be described in detail below. The drawings and the embodiment are not intended to limit the present invention to the specific embodiment disclosed here, and the present invention includes all of modifications, equivalents, and alternatives that can be made within the scope of the accompanying claims.

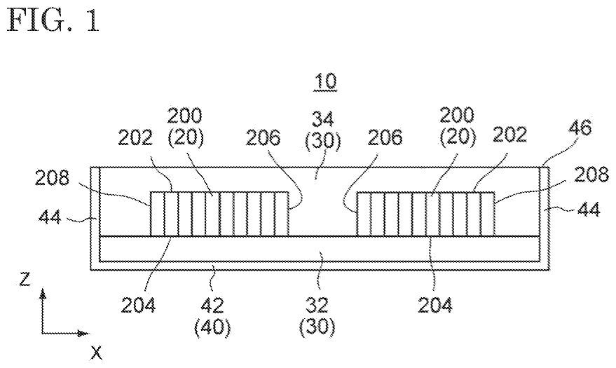

With reference to FIG. 1, a coil component 10 according to an embodiment of the present invention includes a conductor 20 which generates a magnetic flux by being energized, a core 30 which is provided around the conductor and forms a magnetic path through which the magnetic flux circulates, and a case 40 storing the conductor 20 and the core 30.

s is found from FIG. 1, the conductor 20 is a winding wound around an axis along the up-down direction (first direction), thus forming a coil 200. In the present embodiment, one coil 200 is provided. However, the present invention is not limited thereto. A plurality of the coils 200 may be provided. The plurality of coils 200 may be arranged in the up-down direction or may be arranged in the horizontal direction (second direction) perpendicular to the up-down direction. In any case, the plurality of coils 200 may be provided so as to be magnetically coupled with each other, or may be provided so as not to be magnetically coupled with each other. In the present embodiment, the up-down direction is a Z direction, a +Z direction is an upward direction, and a −Z direction is a downward direction. In addition, the horizontal direction is an X direction.

As is found from FIG. 1, in the present embodiment, the conductor 20 is a rectangular wire whose cross-section has substantially a rectangular shape. The coil 200 is a flatwise coil formed by winding the rectangular wire in the thickness direction. As the rectangular wire, for example, a polyamide-imide wire (AIW) formed by coating a copper wire with an insulation coat can be used. The outer surface of the coil. 200 may be further coated with an insulation coat (not shown).

As is found from FIG. 1, the coil 200 has a pair of end surfaces 202, 204, and an inner circumferential surface 206 and an outer circumferential surface 208 connecting the end surfaces 202, 204. As seen along the up-down direction, the shape of the end surface 202 or 204 is an annular polygon or a circle. In the present embodiment, as seen along the u-down direction, the shape of the end surface 202 or 204 is an annular quadrangle with rounded corners.

As shown in FIG. 1, when the coil component 10 is cut along a plane including the magnetic path and the axis of the coil 200, the coil 200 has two cross-sections. Each of these two cross-sections forms a winding window. In the present invention, the winding window refers to the cross-section of the coil 200 around which the circulating magnetic flux is formed, on the plane including the magnetic path and the axis of the coil 200. In the present embodiment, the shape of each winding window is substantially a quadrangle. That is, each winding window has two side lines extending in the up-down direction and two side lines extending in the horizontal direction.

As shown in FIG. 1, in a case where one coil 200 is provided, there are two winding windows. In a case where a plurality of the coils 200 are provided, the number of the winding windows depends on the number of the coils 200 and the arrangement thereof. For example, in a case where two coils 200 having the same shape are overlaid in the up-down direction coaxially with each other, the cross-sections of the plurality of coils 200 close to each other in the up-down direction form one winding window. In this case, there are two winding windows. In a case where two coils 200 having the same shape are placed side by side with their axes parallel to each other, the cross-sections of the coils 200 close to each other form one winding window. In this case, there are three winding windows. The cross-sections of the plurality of coils 200 forming one winding window do not necessarily contact with each other. The cross-sections of the coils 200 close to each other form one winding window even if there is a gap therebetween. In addition, in a case where there are insulating coats, etc., coating the outer surfaces of the coils 200, the insulating coats, etc., are also included in the winding window. In any case, the coil component 10 forms two or more winding windows on the plane including the magnetic path and the axis of the coil 200. The two or more winding windows are arranged along the horizontal direction.

As shown in FIG. 1, the core 30 includes a first core 32 and a second core 34. The first core 32 is placed under the coil 200 in the up-down direction, and contacts with the end surface 204. The first core 32 is present only at a lower position than the end surface 204 of the coil 200, and is not present at a higher position than the end surface 204. In other words, the first core 32 is located on a side opposite to the winding window with respect to a line including one side line contacting with the coil 200 on the plane including the magnetic path.

As is found from FIG. 1, as seen along the up-down direction, the outer shape of the first core 32 is larger than the outer shape of the coil 200. In other words, as seen along the up-down direction, the coil 200 is placed on the inner side relative to the outer periphery of the first core 32. On the plane including the magnetic path, the first core 32 contacts the entirety of one side line extending in the horizontal direction of the winding window and protrudes outward in the horizontal direction from both ends of the one side line. However, the present invention is not limited thereto. The first core 32 may contact with the entirety of the one side line extending in the horizontal direction of each of the winding windows and protrude outward in the horizontal direction from both ends of one side line of at least one of the winding windows.

As shown in FIG. 1, the second core 34 is placed on the upper side of the first core 32 and the coil 200 in the up-down direction. As seen along the up-down direction, the outer shape of the second core 34 substantially coincides with the outer shape of the first core 32. The second core 34 is formed so as to surround the coil. 200, and contacts with the end surface 202, the inner circumferential surface 206, and the outer circumferential surface 208 of the coil 200. In other words, the second core 34 contacts with three side lines other than the one side line of the winding window with which the first core 32 contacts, on the plane including the magnetic path.

The first core 32 and the second core 34 are different in magnetic permeability (μ). When the first core 32 has a first magnetic permeability μ1, the second core 34 has a second magnetic permeability μ2 lower than the first magnetic permeability μ1. In other words, the first core 32 is a high-μ core and the second core 34 is a low-μ core. In the present embodiment, the first core 32 is a dust core, and the second core 34 is a cast core. Here, the dust core is formed by compression-molding soft magnetic alloy powder with a binding agent. In addition, the cast core is formed by curing slurry containing soft magnetic alloy powder, a binder (resin), and the like. In general, the dust core can be formed to have a magnetic permeability (μ) higher than that of the cast core.

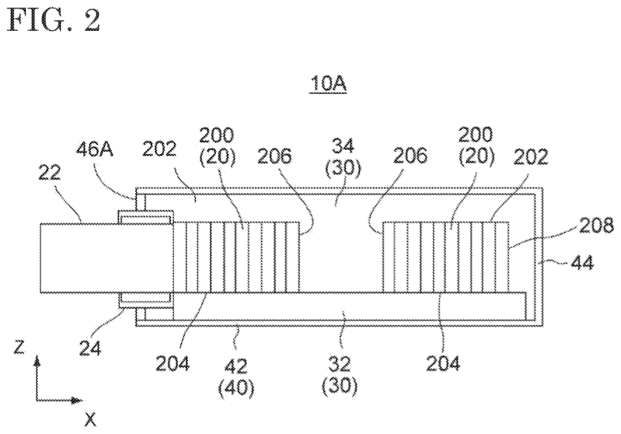

As is found from FIG. 1, the case 40 is a lidless case having a bottom 42 and a side portion 44 protruding upward from the periphery of the bottom 42. In other words, the case 40 has an opening 46 that opens upward. The case 40 is made of metal such as aluminum. The first core 32 contacts with at least the bottom 42 of the case 40. Thus, heat generated from the coil 200 efficiently transfers through the first core 32 to the case 40. Normally, the case is connected to a heat dissipation mechanism or the like (not shown). However, the present invention is not limited thereto. The case 40 may have an opening that opens in a direction perpendicular to the up-down direction, instead of the opening 46 that opens upward. For example, as shown in FIG. 2, the case 40 may have an opening 46A that opens in the horizontal direction. The opening that opens in the direction perpendicular to the up-down direction can be used for leading an end 22 of the conductor 20 to the outside of the case 40.

With reference to FIG. 2, the opening 46A is provided with a cap member 24 surrounding the end 22 of the conductor 20 so that the end 22 of the conductor 20 does not directly contact with the first core 32 and the second core 34. The cap member 24 extends from the outer side of the opening 46 to the outer circumferential surface of the first core 32 or the vicinity thereof, in the horizontal direction. The second core 34 is provided between the first core 32 and the opening 46A so that the first core 32 does not contact with the outside air. However, the boundary between the cap member 24 and the second core 34 can be an entry path of the outside air from the outside of the case 40 to the first core 32. In particular, if the length (shortest distance) of the entry path is smaller than 5 mm, there is a high possibility that the outside air reaches the first core 32. The outside air having reached the first core 32 can be a factor for black rust formed on the surface of the first core 32.

As is found from FIG. 1, the magnetic flux generated by the coil 200 being energized mainly passes the insides of the first core 32 and the second core 34. That is, the first core 32 and the second core 34 form the magnetic path through which the magnetic flux circulates.

AC voltage at a frequency of not less than 20 kHz, e.g., 30 kHz, is applied to the coil 200. In other words, the drive frequency of the coil component 10 is not less than 20 kHz. In order to obtain stable characteristics at such a high drive frequency, in the present invention, the surface resistance of the first core 32 is not less than a predetermined value. Specifically, the surface resistance of the first core 32 between two points that are 20 mm away from each other is not less than 5Ω (room temperature) after a high-temperature storage test. More preferably, the surface resistance of the first core 32 between two points that are 20 mm away from each other is not less than 30Ω (room temperature) after the high-temperature storage test. Thus, by imparting the first core 32 with a surface resistance not less than the predetermined value, change in the characteristics of the coil component 10 is suppressed even in a case where the drive frequency is high.

In the present embodiment, the high-temperature storage test is performed in conformity with the high-temperature test method prescribed in C 60068-2-2:2010 of Japanese Industrial Standards (JIS). Specifically, the high-temperature storage test is performed as follows: the coil component 10 is introduced, the temperature of a test chamber is set at 200° C., and this state is kept for not less than 500 hours. The keeping period may be set to not less than 1000 hours, e.g., 2000 hours, but change in the surface resistance is often saturated around when 500 hours have passed. Therefore, it is considered that 500 hours are sufficient for the keeping period.

In order to set the surface resistance of the first core 32 to not less than the predetermined value, magnetic powder having a high electrical resistivity can be used. As the magnetic powder used for the first core 32, magnetic powder having an electrical resistivity not less than 20 μΩcm (room temperature) can be used. An example of such magnetic powder is a Fe—Si based alloy. The Fe—Si based alloy exhibits a higher electrical resistivity than pure iron. For example, the electrical resistivity of pure iron is 10 μΩcm, whereas the electrical resistivity of a Fe—Si alloy with 1 wt % of Si added thereto is about 20 μΩcm. In addition, the electrical resistivity of a Fe—Si alloy with 3 wt % of Si added thereto is about 50 μΩcm.

As an index relevant to the surface resistance of the first core 32, there is an initial electrical resistivity of the first core 32. If the initial electrical resistivity of the first core 32 is not less than a predetermined value, change in the characteristics of the coil component 10 is suppressed even in a case where the drive frequency is high. Specifically, it is preferable that the initial electrical resistivity of the first core 32 is not less than 10¹⁰ μΩcm. Since the initial electrical resistivity of a dust core using pure iron is about 10⁹ μΩcm, the first core 32 has an initial electrical resistivity higher than the above value by about one digit or more. For example, the initial electrical resistivity of the dust core using the Fe—Si based alloy described above is not less than 10¹² μΩcm.

In order to suppress production of black rust on the first core 32, the surface of the first core 32 may be coated with a coating material. In this case, the first core 32 may be formed by coating, with a coating material, the surface of a dust core using pure iron, or the first core 32 may be formed by coating, with a coating material, the surface of a dust core using a Fe—Si alloy or the like. It is preferable that the gas permeability coefficient of the coating material is not greater than 100 cc(STP)cm/(cm²·sec·cmHg). As such a coating material, for example, epoxy resin or polyamide-based resin can be used. By the coating material, production of black rust on the first core 32 is suppressed, and thus change in the characteristics of the coil component 10 can be suppressed even at a high drive frequency.

The effect obtained by setting the surface resistance of the first core 32 to not less than the predetermined value is significant when the proportion of a component corresponding to the coil 200 in an AC resistance Rac of the coil component 10 is small. In other words, when the proportion of the component corresponding to the coil 200 in the AC resistance Rac of the coil component 10 is great, the effect of the present invention is limited. Therefore, it is desirable that the proportion of the component corresponding to the coil 200 in the AC resistance Rac of the coil component is small. Here, the proportion of the component corresponding to the coil 200 in the AC resistance Rac of the coil component depends on the number of turns of the coil. That is, in the present embodiment, it is preferable that the number of turns of the coil 200 is small. Specifically, it is preferable that the number of turns of the coil 200 is not greater than 30.

The influence of the number of turns of the coil 200 on the effect of the present invention is limited when the influence of the core 30 on the magnetic characteristics of the coil component 10 is small. In other words, when the influence of the core 30 on the magnetic characteristics of the coil component 10 is great, the present invention is particularly effective. Specifically, when the ratio of the inductance of the coil component 10 to the inductance of the coil 200 is not less than 4, the present invention is particularly effective.

In a case where the coil component 10 includes a plurality of the coils 200 and these coils 200 are magnetically coupled with each other, when the coil component is driven in, for example, a two-phase interleaved manner, the change frequency of the magnetic flux is doubled as compared to when the coil component 10 is driven in a single-phase manner. The present invention is particularly effective for the coil component. 10 including the plurality of coils 200 magnetically coupled with each other as described above.

As described above, the present invention can obtain a coil component having stable characteristics such that change in the characteristics is small even at a high drive frequency.

While the present invention has been described using some embodiments, the present invention is not limited to the above embodiments and may be modified or changed in various manners without deviating from the gist of the present invention. For example, the coil 200 may be an edgewise coil. In addition, the shape of the cross-section of the conductor 20 is not limited to a rectangle, and may be a circle or a square.

While the best-mode embodiment of the present invention has been described, it is obvious that a person skilled in the art can modify the embodiment without deviating from the gist of the present invention, and such a modified embodiment is included in the scope of the present invention.

### DESCRIPTION OF THE REFERENCE CHARACTERS

10, 10A coil component
20 conductor
22 end
24 cap member
200 coil
202, 204 end surface
206 inner circumferential surface
208 outer circumferential surface
30 core
32 first core (dust core)
34 second core (cast core)
40 case
42 bottom
44 side portion
46, 46A opening

1. A coil component comprising:
a conductor which generates a magnetic flux by being energized;
a core which is provided around the conductor and forms a magnetic path through which the magnetic flux circulates; and
a case storing the conductor and the core, wherein
a drive frequency of the coil component is not less than 20 kHz,
the conductor is a winding forming at least one coil having an axis along a first direction,
the conductor has a cross-section forming a quadrangular winding window on a plane including the magnetic path,
the plane includes the axis,
the coil forms two or more said winding windows on the plane,
the winding windows are arranged in a second direction perpendicular to the first direction,
the core includes a first core having a first magnetic permeability and a second core having a second magnetic permeability lower than the first magnetic permeability,
on the plane, the first core contacts with an entirety of one side line extending in the second direction of each of the winding windows, protrudes in the second direction from both ends of the one side line of at least one of the winding windows, and is located on a side opposite to the winding windows with respect to a line including the one side line of each of the winding windows,
the second core contacts with three side lines other than the one side line of each of the winding windows on the plane,
the case has a bottom and a side portion extending in one direction from the bottom,
the first core contacts with the bottom,
the first core is a dust core, and
a surface resistance of the dust core between two points that are 20 mm away from each other is not less than 5Ω after a high-temperature storage test.

2. The coil component according to claim 1, wherein
an electrical resistivity of magnetic powder used for the dust core is not less than 20 μΩcm.

3. The coil component according to claim 1, wherein
an initial electrical resistivity of the dust core is not less than 10¹⁰ μΩcm.

4. The coil component according to claim 1, wherein
a ratio of an inductance of the coil component to an inductance of the coil is not less than 4.

5. The coil component according to claim 1, wherein
a surface of the dust core is coated with a coating material, and
a gas permeability coefficient of the coating material is not greater than 100 cc(STP)cm/(cm²·sec·cmHg).

6. The coil component according to claim 1, wherein
a number of turns of the coil is not greater than 30.

7. The coil component according to claim 1, wherein
a plurality of the coils are provided, and
the plurality of coils are magnetically coupled with each other.

8. The coil component according to claim 1, wherein
the surface resistance of the dust core between the two points that are 20 mm away from each other is not less than 30Ω after the high-temperature storage test.

9. The coil component according to claim 1, wherein
the high-temperature storage test is a heating test at 200° C. for not less than 500 hours.
